(19) United States
(12) Patent Application Publication
(10) Pub. No.: US 2019/0068011 A1
(43) Pub. Date: Feb. 28, 2019

(54) INTERIOR PERMANENT MAGNET ELECTRIC MACHINE

(71) Applicant: HIWIN MIKROSYSTEM CORP., Taichung City (TW)

(72) Inventors: Zhe-Wei ZHANG, Taichung City (TW); Chen-nan KUO, Taichung City (TW)

(21) Appl. No.: 15/683,163

(22) Filed: Aug. 22, 2017

(51) Int. Cl. H02K 1/27

(52) U.S. Cl. CPC H02K 1/276

(57) ABSTRACT

An interior permanent magnet electric machine including a stator, a rotor, a plurality of magnet units and a plurality of divisions is provided. The magnet units are contained within the slots of the rotor. Each magnet unit includes at least two magnets, and the divisions are configured between the neighboring magnets to separate the magnets such that the magnetic distribution is enlarged and the torque ripple is decreased.

### BACKGROUND OF THE INVENTION

### Field of the Invention

The invention relates to an electric machine, and more particularly to an interior permanent magnet electric machine.

### Description of the Related Art

The spindle motor is generally applied to the machine tool, such as lathe or milling machine, to provide rotation for the workpiece or tool to perform various operations.

Concerning to the tradeoff between the cost and the efficiency, the conventional machine tool usually takes the asynchronous electric machine as the spindle motor. With the development of the electric machine, the permanent magnet synchronous electric machine has gradually been substituted for the asynchronous electric machine as the spindle motor.

Although the permanent magnet electric machine can enhance the efficiency by increasing the constant power speed range with the magnet control technology, the vibration and the noise will affect the operation thereof. With respect to the conventional technology, the U.S. Pat. No. 8,981,611 disclosed two indentations of different shapes configured at the opposite ends of the magnet to reduce the cogging of the permanent magnet electric machine.

### SUMMARY OF THE INVENTION

In view of the disadvantages of prior art, the object of the present invention is to provide an interior permanent magnet electric machine to reduce the eddy loss and the torque ripple.

To achieve the above object, the present invention provides an interior permanent magnet electric machine including a stator, a rotor, a plurality of magnet units and a plurality of divisions wherein the magnet units are contained within the slots of the rotor. Each magnet unit includes at least two magnets, and the divisions are configured between the neighboring magnets to separate the magnets such that the magnetic distribution is enlarged.

The divisions are non-conductive material, such as air, adhesive, epoxy, insulator, plastic or the combination thereof. Besides, the magnets are pre-assembled with the divisions as a whole, and then the pre-assembled part is inserted into the slot to facilitate the fabrication.

The rotor core includes a radial axis, and each magnet unit includes a magnet axis whereby the radial axis is crossed with the magnet axis to provide an angle within the range between 85° and 90°. Thus, the angle α can enlarge the magnetic spread angle and the distribution of the magnets to provide continuous magnetic field line between the neighboring magnet units and decrease the torque ripple.

Each magnet unit includes multiple magnets with the same or different size to regulate the magnetic distribution, and the divisions are configured between the neighboring magnets or the lateral spaces within each slot.

Furthermore, the adjacent magnetic poles of the neighboring magnets are different, and the protrusions are disposed between the neighboring magnets for fix and separation of the magnets.

### BRIEF DESCRIPTION OF THE DRAWINGS

FIG. 1 is a schematic view of the first embodiment of the present invention;

FIG. 2 is a cross sectional view of the first embodiment of FIG. 1 along a section line 2-2;

FIG. 3 a partial enlarged view according to FIG. 2;

FIG. 4 is a magnetic distribution diagram according to the first embodiment.

### DETAILED DESCRIPTION OF THE PREFERRED EMBODIMENTS

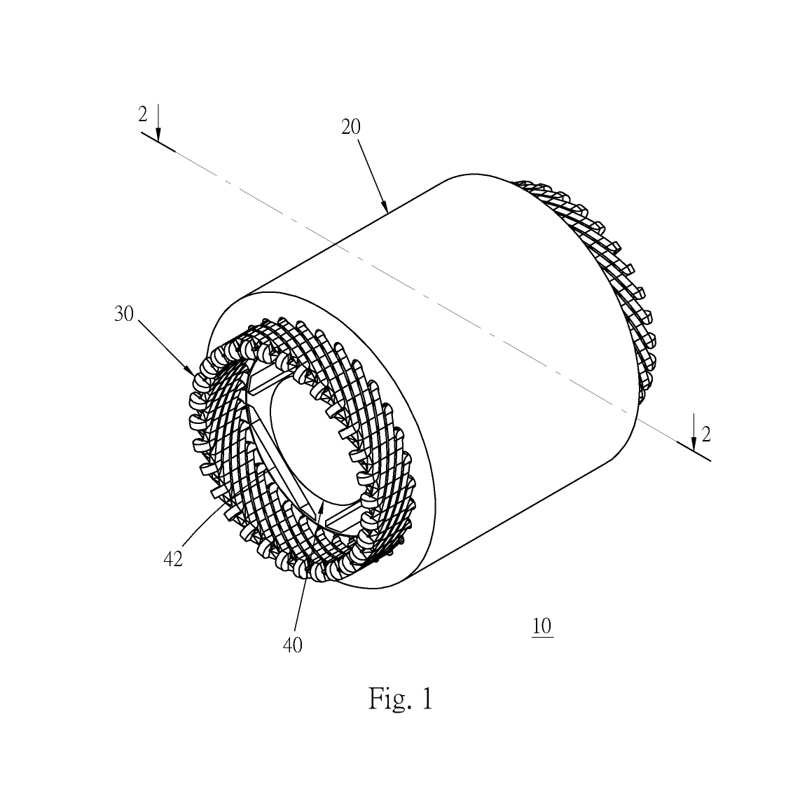

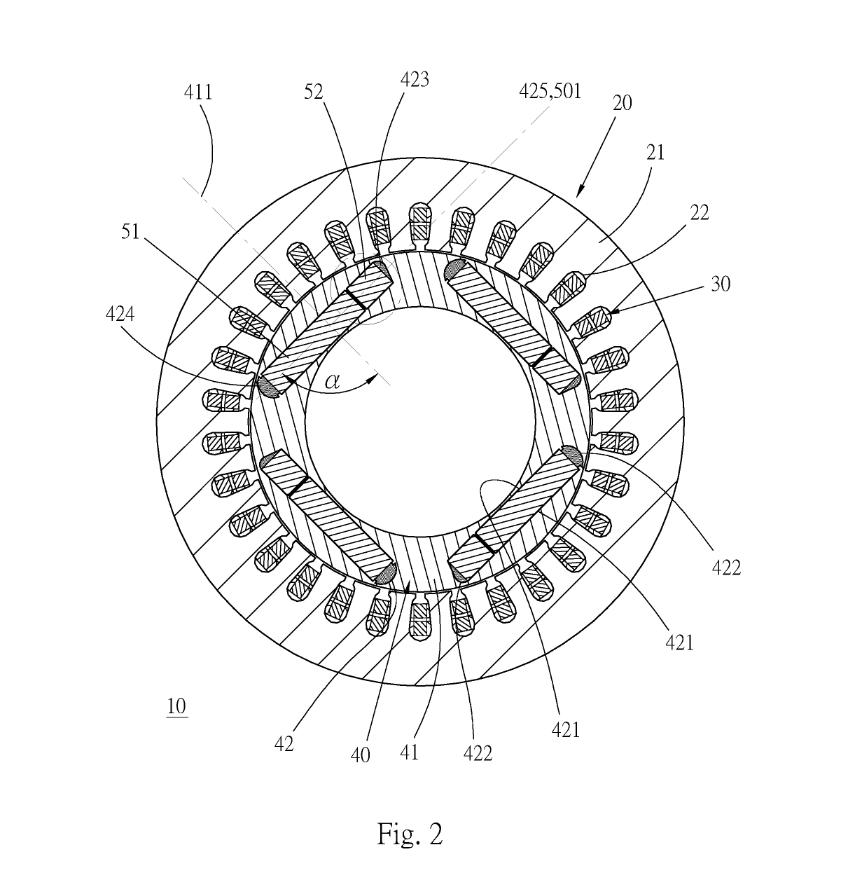

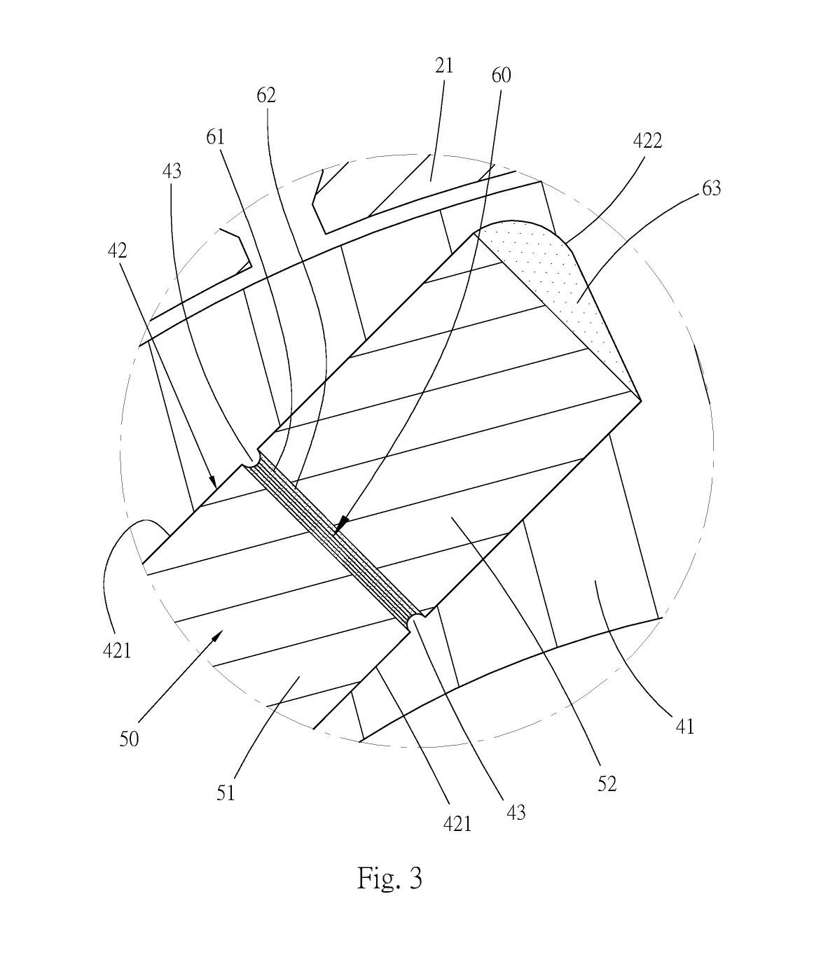

Refer to FIG. 1 to FIG. 3. The interior permanent magnet electric machine 10 includes a stator 20, a plurality of coils 30 and a rotor 40, a plurality of magnet units 50 and a plurality of divisions 60.

The stator 20 includes a circular stator core 21 and grooves 22 wherein the grooves 22 are configured on the inner circumference of the stator core 21 radially. The coils 30 are distributing winded within the grooves 22 respectively, but the coils 30 can be centralizing winded within the grooves 22 respectively in other embodiment. The technology of the stator 20 and the coils 30 is mature prior art, so there is no more detailed description herein.

The rotor 40 includes a rotor core 41, a plurality of slots 42 and a plurality of protrusions 43. The rotor core 41 is configured by stacking a plurality of silicon steel sheets. The slots 42 are equally and respectively disposed on the rotor core 41 in the form of long and narrow holes. The protrusions 43 are symmetrically disposed on an inner wall 421 of the slot 42.

The magnet units 50 are contained within the slots 42 in the form of strip shape. The gap between the end of each magnet unit 50 and the side wall 422 of the slot 42 has different distance from the gap between the other end of each magnet unit 50 and the side wall 422 of the slot 42. Therefore, the spaces 423/424 disposed between the magnet unit 50 and the side wall 422 of the slot 42 are asymmetrical. The rotor core 41 includes a radial axis 411, and each magnet unit 50 includes a magnet axis 501 whereby the radial axis 411 is crossed with the magnet axis 501 to provide an angle α. In this embodiment, each slot 42 includes a slot axis 425 coaxial to the magnet axis 501 of the magnet unit 50 such that the slot axis 425 is crossed with the radial axis 411 to provide the same angle α. The angle α is provided within the range between 85° and 90°.

Moreover, each magnet unit 50 disposed within each slot 42 includes two strip magnets 51/52 with different size wherein the adjacent magnetic poles are different. The protrusions 43 are disposed between the neighboring magnets 51/52 symmetrically for fix and separation of the magnets 51/52.

The divisions 60 are configured between the neighboring magnets 51/52 or the spaces 423/424 within each slot 42. The divisions 60 are non-conductive material, such as air, adhesive, epoxy, insulator, plastic or the combination thereof. In this embodiment, the plastic or insulating plate 61 is put between the magnets 51/52 to separate the magnets 51/52, and the adhesive 62 is provided to connect the plastic or insulating plate 61 and the magnets 51/52. The pre-assembled part including the plastic or insulating plate 61 and the magnets 51/52 is inserted into the slot 42, and then the slot 42 is filled with the epoxy for package. Accordingly, the spaces 423/424 are filled with the epoxy to provide the divisions 60 corresponding to the opposite ends of the magnet unit 50.

The interior permanent magnet electric machine 10 includes the following effects:

First, the magnet unit 50 consists of multiple magnets wherein the magnets with small size are processed easily, and includes lower eddy loss to increase motor efficiency.

Second, compared with the conventional magnets configuration without separation means, the magnets configuration with the divisions 60 can enlarge the magnetic spread angle and the distribution.

Third, the pre-assembly of the magnets 51/52 and the divisions 60 can provide superior connection through the epoxy filling package.

Fourth, the protrusions 43 can provide the fix and separation for the magnets 51/52.

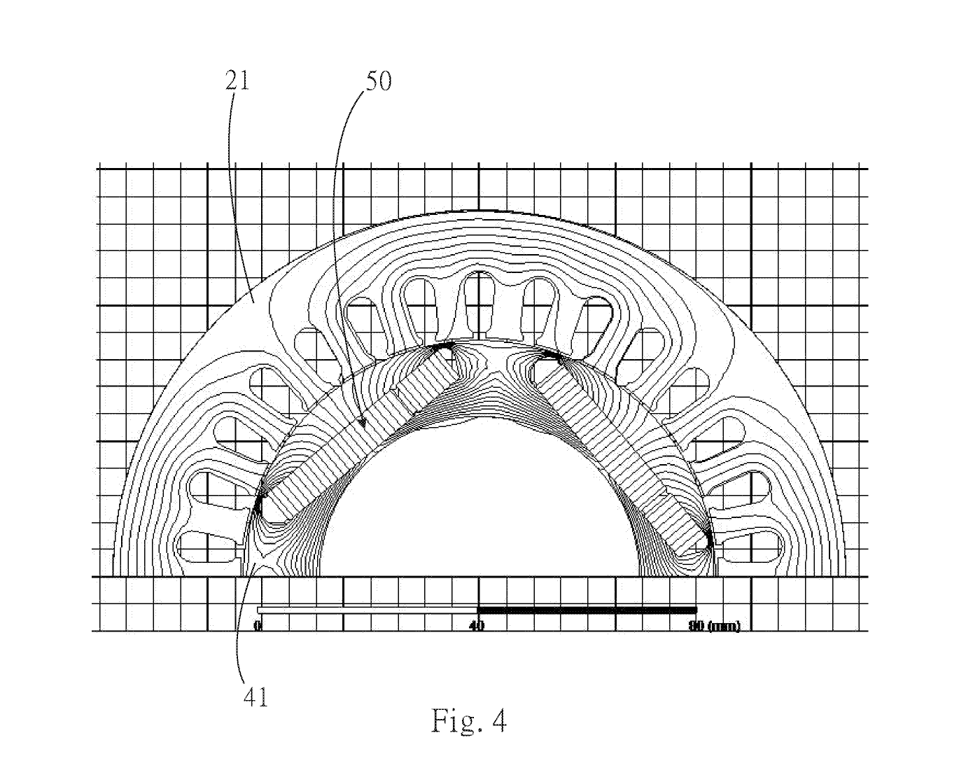

Fifth, the angle α can also enlarge the magnetic spread angle of the magnets 50 and provide continuous magnetic field line between the neighboring magnet units 50 (refer to FIG. 4) to decrease the torque ripple.

It will be apparent to those skilled in the art that various modifications and variations can be made to the structure of the invention without departing from the scope or spirit of the invention. In view of the foregoing, the size and the shape of the divisions, the magnets and the spaces can be adjusted according to the motor requirement in order to enlarge the magnetic spread angle.

What is claimed is:

1. An interior permanent magnet electric machine, comprising:
a stator;
a rotor, comprising a rotor core and a plurality of slots wherein the rotor core is held within the stator coaxially, and the slots are equally disposed on the rotor core respectively;
a plurality of magnet units, contained within the slots wherein each of the magnet unit comprises at least two magnets; and
a plurality of divisions, configured between the neighboring magnets.

2. The interior permanent magnet electric machine as claimed in claim 1, wherein the rotor core comprises a radial axis, and each of the magnet units comprises a magnet axis whereby the radial axis is crossed with the magnet axis to provide an angle.

3. The interior permanent magnet electric machine as claimed in claim 2, wherein each of the slots comprises a slot axis crossed with the radial axis to provide the angle.

4. The interior permanent magnet electric machine as claimed in claim 2, wherein the angle is provided within the range between 85° and 90°.

5. The interior permanent magnet electric machine as claimed in claim 3, wherein the angle is provided within the range between 85° and 90°.

6. The interior permanent magnet electric machine as claimed in claim 1, wherein the shape and the size of the magnets of each of the magnet unit are different or the same.

7. The interior permanent magnet electric machine as claimed in claim 1, wherein the rotor comprises a plurality of protrusions disposed on an inner wall of the slot and between the neighboring magnets.

8. The interior permanent magnet electric machine as claimed in claim 1, wherein the divisions are disposed between the magnet unit and a side wall of the slot.

9. The interior permanent magnet electric machine as claimed in claim 8, wherein the divisions disposed between the magnet unit and the side wall of the slot are symmetrical or asymmetrical.

10. The interior permanent magnet electric machine as claimed in claim 1 wherein the divisions are air, adhesive, epoxy, insulator or plastic.

11. The interior permanent magnet electric machine as claimed in claim 8, wherein the divisions are air, adhesive, epoxy, insulator or plastic.

12. The interior permanent magnet electric machine as claimed in claim 9, wherein the divisions are air, adhesive, epoxy, insulator or plastic.

13. The interior permanent magnet electric machine as claimed in claim 1, further comprising a plurality of coils distributing or centralizing winded on a stator core of the stator.
